(19) United States
(12) Patent Application Publication
(10) Pub. No.: US 2023/0223771 A1
(43) Pub. Date: Jul. 13, 2023

(54) POWER BASE

(71) Applicant: Raffel Systems, LLC, Germantown, WI (US)

(72) Inventor: Jeff Malinowski, Slinger, WI (US)

(21) Appl. No.: 17/573,170

(22) Filed: Jan. 11, 2022

(51) Int. Cl. H01R 33/92; H02J 7/00; H02J 7/02; F21V 23/04

(52) U.S. Cl. CPC H01R 33/92; H02J 7/0042; H02J 7/02; F21V 23/04

(57) ABSTRACT

A power base including a housing with a support surface, a bottom surface parallel to the support surface, and a side surface extending between the support surface and the bottom surface. The housing at least partially defines a cavity. A power supply is positioned within the cavity, and a user interface is positioned on the side surface. The user interface is electrically coupled to the power supply. The housing is configured to support an object positioned on the support surface.

### TECHNICAL FIELD

The present disclosure relates to power bases, and more particularly to electrical power bases or electrical power strips.

### BACKGROUND

Conventional power strips include a plurality of electrical outlets, but can be bulky, unsightly, and take up valuable space. For example, a conventional power strip positioned on top of a side table in a hotel room, for example, takes up space on the side table that could otherwise be used for another object (e.g., lamp, clock, sign, decor, etc.).

### SUMMARY

The disclosure provides, in one aspect, a power base including a housing with a support surface, a bottom surface parallel to the support surface, and a side surface extending between the support surface and the bottom surface. The housing at least partially defines a cavity and a power supply is positioned within the cavity. The power base further includes a user interface positioned on the side surface, wherein the user interface is electrically coupled to the power supply. The housing is configured to support an object positioned on the support surface.

In some embodiments, a weight of the object positioned on the support surface is up to 50 pounds.

In some embodiments, the object is electrically coupled to the user interface.

In some embodiments, the object is a lamp.

In some embodiments, the support surface is planar.

In some embodiments, the side surface is a first side surface and the housing further includes a second side surface extending between the support surface and the bottom surface, a third side surface extending between the support surface and the bottom surface, and a fourth side surface extending between the support surface and the bottom surface.

In some embodiments, the first side surface extends parallel to the second side surface.

In some embodiments, the third side surface and the fourth side surface extend perpendicular to the first side surface.

In some embodiments, the third side surface extends parallel to the fourth side surface.

In some embodiments, the user interface is a first user interface positioned on the first side surface, and the power base further including a second user interface positioned on the second side surface, a third user interface positioned on the third side surface, and a fourth user interface positioned on the fourth side surface.

In some embodiments, the housing defines a length, a width, and a height; wherein the height is measured from the bottom surface to the support surface; and wherein the width is at least six times larger than the height, and wherein the length is at least eight times larger than the height.

In some embodiments, the housing includes a main body and a cover removably coupled to the main body, and wherein the bottom surface is formed on the cover.

In some embodiments, the user interface is an AC outlet, a USB-A outlet, a USB-C outlet, a switchable AC outlet, a button, a switch, a light source, a clock, an alarm, a wired charger, or a wireless charger.

In some embodiments, the user interface is one of a plurality of user interfaces, and wherein each of the plurality of user interfaces is positioned on the side surface.

In some embodiments, the housing includes a plurality of ribs positioned in the cavity, and wherein the plurality of ribs transfer a weight of the object positioned on the support surface to the bottom surface.

In some embodiments, the housing defines a length, a width, and a height; and wherein the height is measured from the bottom surface to the support surface; and wherein the width is at least six times larger than the height, and wherein the length is at least eight times larger than the height.

In some embodiments, the power base further includes an indicia positioned on the support surface or the side surface.

In some embodiments, the power base further includes a light source and wherein the housing includes a light pipe coupled to the light source.

The disclosure provides, in one aspect, a power base including a housing with a main body, a cover, and a light pipe. The main body includes a planar support surface, and the cover includes a bottom surface parallel to the support surface. The housing further includes a first side surface extending between the support surface and the bottom surface, a second side surface extending between the support surface and the bottom surface, a third side surface extending between the support surface and the bottom surface, and a fourth side surface extending between the support surface and the bottom surface. The main body and the cover at least partially define a cavity, and a power supply is positioned within the cavity. The power base further includes a light source coupled to the light pipe and a switchable AC outlet positioned on the second side surface. The power base further includes a first switch, a second switch, a USB-C outlet, and a USB-A outlet positioned on the first side surface. The first switch is electrically coupled to the switchable AC outlet, and the second switch is electrically coupled to the light source. A first AC outlet is positioned on the third side surface and a second AC outlet is positioned on the fourth side surface. The power base further includes a wireless charger positioned within the cavity and coupled to the support surface. Each of the light source, the switchable AC outlet, the first AC outlet, the second AC outlet, the USB-C outlet, the USB-A outlet, and the wireless charger are electrically coupled to the power supply.

In some embodiments, the housing has a compressive strength of at least two psi.

Other aspects of the disclosure will become apparent by consideration of the detailed description and accompanying drawings.

### BRIEF DESCRIPTION OF THE DRAWINGS

FIG. 1 is perspective view of a power base supporting an object shown in dashed lines.

FIG. 2 is another perspective view of the power base of FIG. 1.

FIG. 3 is a side view of the power base of FIG. 1 supporting an object shown in dashed lines.

FIG. 4 is a top perspective exploded view of the power base of FIG. 1.

FIG. 5 is a bottom perspective exploded view of the power base of FIG. 1.

Before any embodiments are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present disclosure. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

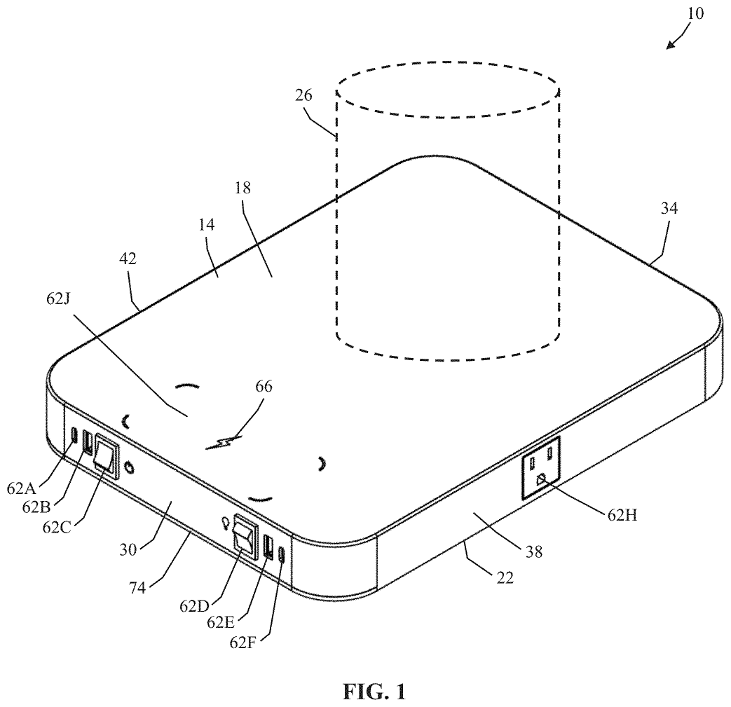

With reference to FIG. 1-3, a power base 10 (e.g., a power pad, a power strip) includes a housing 14 with a support surface 18 (e.g., a top surface) and a bottom surface 22 parallel to the support surface 18. In the illustrated embodiment, the support surface 18 is planar. As described in greater detail herein, the housing 14 is configured to support an object 26 positioned on the support surface 18. In some embodiments, the object 26 is electrically coupled to the power base 10 in addition to being supported by the power base 10. In some embodiments, the object 26 is a lamp. In other embodiments, the object 26 is a clock, a radio, a television, a phone, a display, a decorative item, an electronic device, a household item, or any other suitable item. Conventional power strips are typically positioned on the floor, wall, or table top but are not configured to support any objects.

The housing 14 includes a first side surface 30, a second side surface 34, a third side surface 38, and a fourth side surface 42, each of which extends between the support surface 18 and the bottom surface 22. In some embodiments, the first side surface 30 extends parallel to the second side surface 34. In some embodiments, the third side surface 38 extends parallel to the fourth side surface 42. In some embodiments, the third side surface 38 and the fourth side surface 42 each extend perpendicular to the first side surface 30 and/or the second side surface 34. In some embodiments, rounded corners connect adjacent side surfaces.

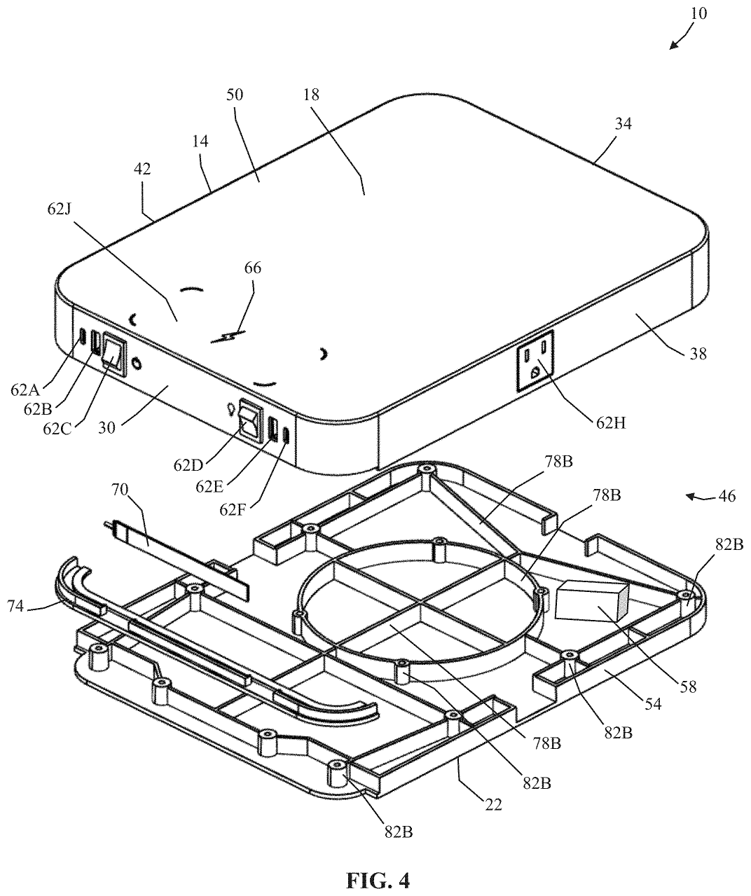

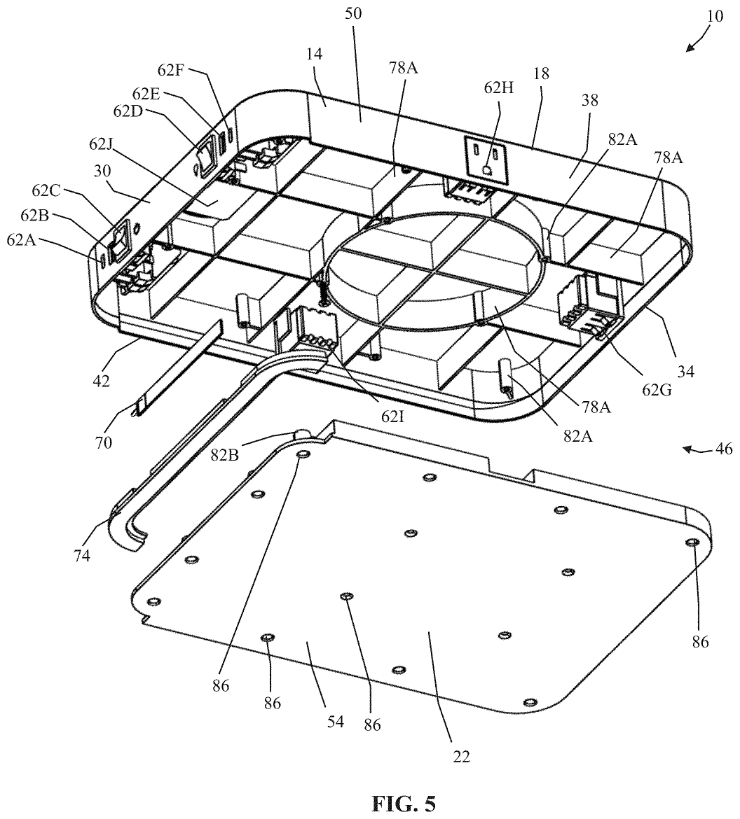

With reference to FIGS. 4-5, the housing 14 at least partially defines a cavity 46 (e.g., an interior chamber). In the illustrated embodiment, the housing 14 includes a main body 50 and a cover 54 removably coupled to the main body 50. In the illustrated embodiment, the bottom surface 22 is formed on the cover 54. In the illustrated embodiment, the main body 50 and the cover 54 at least partially define the cavity 46.

A power supply 58 (FIG. 4) is positioned within the cavity 46. In some embodiments, the power supply is a 100 W power supply (e.g., a class two power supply). In some embodiments, power supply 58 includes a voltage regulator, a circuit protector, a cord, or other suitable electronics.

With continued reference to FIGS. 1-3, the power base 10 includes a plurality of user interfaces 62A-62J that are electrically coupled to the power supply 58. In some embodiments, the user interface is an AC outlet, a USB-A outlet, a USB-C outlet, a switchable AC outlet, a button, a switch, a light source, a clock, an alarm, a wired charger (e.g., a wired phone charger), a wireless charger (e.g., a wireless phone charger), or any other suitable interface between a user and the power base 10.

In the illustrated embodiment, the power base 10 includes a plurality of user interfaces 62A-62F on the first side surface 30 (e.g., front panel user interfaces). In the illustrated embodiment, the plurality of user interfaces on the first side surface 30 includes a first USB-C outlet 62A, a first USB-A outlet 62B, a power switch 62C, a light switch 62D, a second USB-A outlet 62E, and a second USB-C outlet 62F.

In the illustrated embodiment, the power base 10 includes a user interface 62G on the second side surface 34 (e.g., a rear panel user interface). In the illustrated embodiment, the user interface 62G is a switchable AC outlet that is electrically coupled to the power switch 62C. As such, electrical power to the switchable AC outlet 62G may be controlled by user activation of the power switch 62C. For example, in some embodiments, the object 26 is a lamp that is electrically coupled to the switchable AC outlet 62G such that the power switch 62C turns the lamp on and off

In the illustrated embodiment, the power base 10 includes a user interface 62H on the third side surface 38 (e.g., a right panel user interface) and a user interface 62I on the fourth side surface 42 (e.g., a left panel user interface). In the illustrated embodiment, the user interfaces 62H and 62I are AC outlets. In the illustrated embodiment, the power base 10 includes at least one user interface on each of the side surfaces 30, 34, 38, and 42. In some embodiments, all of the user interfaces are positioned on the side surfaces 30, 34, 38, and 42 with no user interfaces positioned on the support surface 18 or the bottom surface 22.

In the illustrated embodiment, the power base 10 includes a user interface 62J on the support surface 18 (e.g., a top user interface). In some embodiments, the user interfaces are positioned on any of the side surfaces 30, 34, 39, 42 or support surface 18, alone or in combination. In the illustrated embodiment, the user interface 62J is a wireless charger (e.g., a wireless phone charger). The wireless charger 62J is positioned within the cavity 46 and is coupled to the support surface 18. In some embodiments, an indicia 66 is positioned on the support surface 18 to indicate to a user where the wireless charger 62J, for example, is integrated into the power base 10. In other words, the indicia 66 indicates the location on the power base 10 a user should place the device to be charged.

With continued reference to FIGS. 4 and 5, the power base 10 further includes a light source 70 and the housing 14 includes a light pipe 74. In the illustrated embodiment, the light pipe 74 is arcuate and extends along the lower front edge of the housing 14. In the illustrated embodiment, the light source 70 is coupled to the light pipe 74. In the illustrated embodiment, the light source 70 is positioned within the cavity 46 and is partially received within the light pipe 74. The light pipe 74 is configured to transmit and/or distribute a light emitted from the light source 70. In the illustrated embodiment, the light source 70 is electrically coupled to the light switch 62D and the power supply 58. As such, power to the light source 70 may be controlled by user activation of the light switch 62D. In some embodiments, the light source 70 is one or more light emitting diode.

In some embodiments, all the user interfaces 62A-62J are electrically coupled to the power supply 58. In the illustrated embodiment, each of the light source 70, the switchable AC outlet 62G, the first AC outlet 62H, the second AC outlet 62I, the USB-C outlets 62A and 62F, the USB-A outlets 62B and 62E, and the wireless charger 62J are electrically coupled to the power supply 58.

In some embodiments, the object 26 supported by the housing 14 is electrically coupled to any of the user interfaces 62A-62J disclosed herein. As a result, the object 26 does not need to be plugged into a nearby wall outlet, which frees up valuable space at the wall outlet. Advantageously, the power base 10 conserves wall outlets in an area because the power base 10 includes a power outlet or switchable power outlet that can be utilized instead of the wall outlet. For example, with the power base 10 plugged into a wall outlet in an area, a lamp in the same area that would have typically been plugged into the wall outlet can be unplugged from the wall outlet and instead plugged into the AC outlet 62H, 62I or the switchable AC outlet 62G on the power base 10. As such, the power base 10 conserves wall outlets.

With reference to FIGS. 4 and 5, the housing 14 includes a plurality of ribs 78A, 78B positioned in the cavity 46. In the illustrated embodiment, both the main body 50 includes ribs 78A and the cover 54 includes ribs 78B. As described herein, the plurality of ribs 78A, 78B transfers a weight of the object 26 positioned on the support surface 18 to the bottom surface 22. In some embodiments, a weight of the object 26 positioned on and supported by the support surface 18 is up to approximately 50 pounds. In other words, the power base 10 is configured to support at least approximately 50 pounds on top of the power base 10. In some embodiments, the housing 14 has a compressive strength of at least approximately two psi.

In some embodiments, the main body 50 includes bosses 82A and the cover 54 includes corresponding bosses 82B that are configured to receive fasteners to removably coupled the cover 54 to the main body 50. In the illustrated embodiment, a fastener is inserted through an aperture 86 formed in the cover 54, and the aperture 86 is aligned with one of each of the bosses 82A, 82B.

In some embodiments, the front portion of the power base 10 (e.g., a front third of the power base) includes most of the user interfaces and the rear portion of the power base 10 (e.g., a rear third of the power base) includes electronics (e.g., the power supply 58) and support structure (e.g., ribs). As described herein, the power base 10 is designed to have heavy loads placed on top of it.

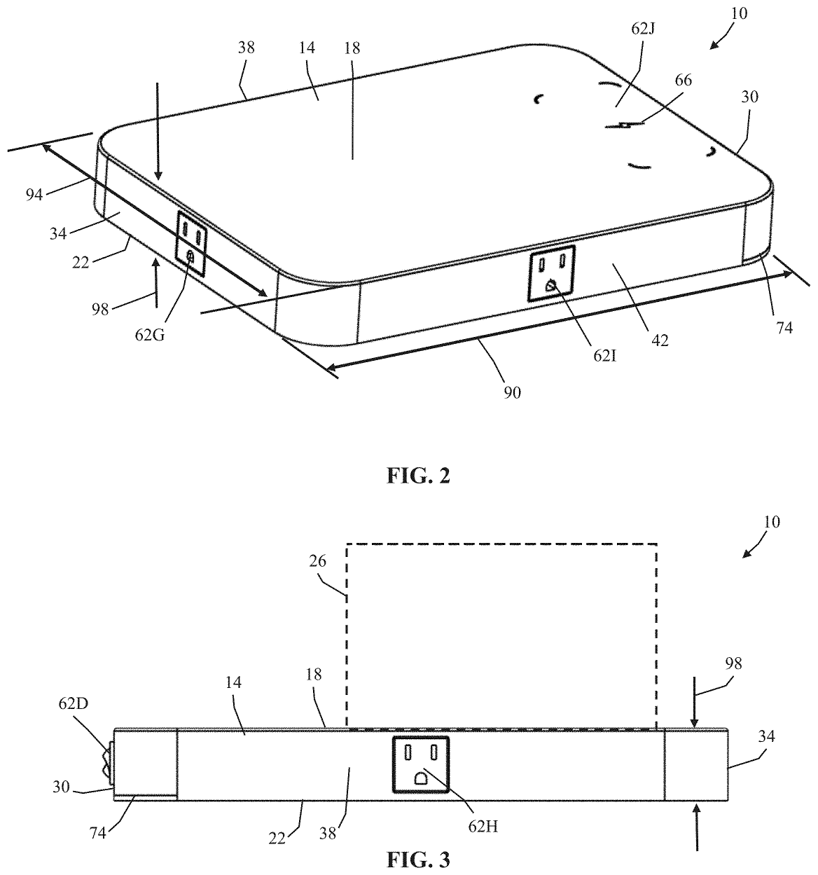

With reference to FIG. 2, the housing 14 defines a length 90, a width 94, and a height 98. In the illustrated embodiment, the height 98 is measured from the bottom surface 22 to the support surface 18; the width 94 is measured between the third side surface 38 and the fourth side surface 42; and the length 90 is measured between the first side surface 30 and the second side surface 34. In the illustrated embodiment, the width 94 is at least six times larger than the height 98. In some embodiments, the width 94 is at least three times larger than the height 98. In the illustrated embodiment, the length 90 is at least eight times larger than the height 98. In some embodiment, the length 90 is at least four times larger than the height 98. In some embodiments, the height 98 is approximately 1.4 inches, the width 94 is approximately 9 inches and the length 90 is approximately 11.9 inches. The support surface 18 has a larger surface area than any of the side surfaces 30, 34, 38, 42. The housing 14 is low-profile, so the object 26 placed on top of the housing 14 is not raised much off the surface supporting the power base 10 (e.g., the floor, tabletop, etc.). In other words, the height 98 is minimized to allow for an object, such as a lamp, to be placed on top of the housing 14 without being over obtrusive. The power base 10 provides a variety of electrical connections without taking up additional tabletop or floor space. The space the power base 10 does occupy can still be utilize by placing an object on top of the power base 10. As such, power base 10 conserves space.

The power base 10 described herein provides a power supply with a variety of electrical connections in an area while maximizing the space by being configured to support an object on top of the power base 10.

Various features and advantages are set forth in the following claims.

What is claimed is:

1. A power base comprising:
a housing with a support surface, a bottom surface parallel to the support surface, and a side surface extending between the support surface and the bottom surface; wherein the housing at least partially defines a cavity;
a power supply positioned within the cavity; and
a user interface positioned on the side surface, wherein the user interface is electrically coupled to the power supply;
wherein the housing is configured to support an object positioned on the support surface.

2. The power base of claim 1, wherein a weight of the object positioned on the support surface is up to 50 pounds.

3. The power base of claim 1, wherein the object is electrically coupled to the user interface.

4. The power base of claim 3, wherein the object is a lamp.

5. The power base of claim 1, wherein the support surface is planar.

6. The power base of claim 1, wherein the side surface is a first side surface and the housing further includes a second side surface extending between the support surface and the bottom surface, a third side surface extending between the support surface and the bottom surface, and a fourth side surface extending between the support surface and the bottom surface.

7. The power base of claim 6, wherein the first side surface extends parallel to the second side surface.

8. The power base of claim 7, wherein the third side surface and the fourth side surface extend perpendicular to the first side surface.

9. The power base of claim 6, wherein the third side surface extends parallel to the fourth side surface.

10. The power base of claim 6, wherein the user interface is a first user interface positioned on the first side surface, and the power base further including a second user interface positioned on the second side surface, a third user interface positioned on the third side surface, and a fourth user interface positioned on the fourth side surface.

11. The power base of claim 10, wherein the housing defines a length, a width, and a height;
wherein the height is measured from the bottom surface to the support surface; and wherein the width is at least six times larger than the height, and wherein the length is at least eight times larger than the height.

12. The power base of claim 1, wherein the housing includes a main body and a cover removably coupled to the main body, and wherein the bottom surface is formed on the cover.

13. The power base of claim 1, wherein the user interface is an AC outlet, a USB-A outlet, a USB-C outlet, a switchable AC outlet, a button, a switch, a light source, a clock, an alarm, a wired charger, or a wireless charger.

14. The power base of claim 1, wherein the user interface is one of a plurality of user interfaces, and wherein each of the plurality of user interfaces is positioned on the side surface.

15. The power base of claim 1, wherein the housing includes a plurality of ribs positioned in the cavity, and wherein the plurality of ribs transfer a weight of the object positioned on the support surface to the bottom surface.

16. The power base of claim 1, wherein the housing defines a length, a width, and a height; wherein the height is measured from the bottom surface to the support surface; and wherein the width is at least six times larger than the height, and wherein the length is at least eight times larger than the height.

17. The power base of claim 1, further including an indicia positioned on the support surface or the side surface.

18. The power base of claim 1, further including a light source and wherein the housing includes a light pipe coupled to the light source.

19. A power base comprising:
a housing with a main body, a cover, and a light pipe; the main body includes a planar support surface, and the cover includes a bottom surface parallel to the support surface,
the housing further includes a first side surface extending between the support surface and the bottom surface, a second side surface extending between the support surface and the bottom surface, a third side surface extending between the support surface and the bottom surface, and a fourth side surface extending between the support surface and the bottom surface;
wherein the main body and the cover at least partially define a cavity;
a power supply positioned within the cavity;
a light source coupled to the light pipe;
a switchable AC outlet positioned on the second side surface;
a first switch, a second switch, a USB-C outlet, and a USB-A outlet positioned on the first side surface, wherein the first switch is electrically coupled to the switchable AC outlet, and the second switch is electrically coupled to the light source;
a first AC outlet positioned on the third side surface and a second AC outlet positioned on the fourth side surface; and
a wireless charger positioned within the cavity and coupled to the support surface;
wherein each of the light source, the switchable AC outlet, the first AC outlet, the second AC outlet, the USB-C outlet, the USB-A outlet, and the wireless charger are electrically coupled to the power supply.

20. The power base of claim 19, wherein the housing has a compressive strength of at least two psi.
